(19) United States
(12) Patent Application Publication
(10) Pub. No.: US 2001/0019947 A1
(43) Pub. Date: Sep. 6, 2001

(54) Casing for electronic equipment, and mobile telecommunication equipment comprising it

(75) Inventors: Stephane Michel, Montfort Sur Meu (FR); Yann Naslain, Rennes (FR); Pascal Roussy, Betton (FR); Jean-Marc Le Foulgoc, Chateaubourg (FR); Mickael Rouxel, Rennes (FR)

Correspondence Address: OBLON SPIVAK MCCLELLAND MAIER & NEUSTADT PC, FOURTH FLOOR, 1755 JEFFERSON DAVIS HIGHWAY, ARLINGTON, VA, 22202, US

(73) Assignee: MITSUBISHI ELECTRIC TELECOM EUROPE, Nanterre (FR)

(21) Appl. No.: 09/796,622

(22) Filed: Mar. 2, 2001

(30) Foreign Application Priority Data
Mar. 2, 2000 (FR) 00 02711

(51) Int. Cl. H04B 1/38

(52) U.S. Cl. 455/90; 455/347; 455/348; 455/349

(57) ABSTRACT

A casing for electronic equipment including first and second structural elements and a structure for mechanically connecting the first and second structural elements by elastic engagement. The structure for mechanical connection including an elastically deformable leg integral with the first structural element, a transverse projection borne by the leg, and a shoulder formed on the second structural element. The shoulder constitutes a stop configured to collaborate with the projection and hold the leg in place. The structure for mechanical connection by elastic engagement includes a structure for immobilizing the projection facing the shoulder.

### CROSS-REFERENCE TO RELATED APPLICATION

The present application is related to French patent application number 00 02711, filed on Mar. 2, 2000, which is hereby incorporated by reference.

### BACKGROUND OF THE INVENTION

1. Field of the Invention

The present invention relates to casings for electronic equipment.

2. Discussion of the Background

Current electronic equipment, particularly mobile telecommunications equipment such as mobile telephones, include a casing made of plastic that house therein electronic circuits which allow operation of the electronic equipment. The casings generally include at least two structural elements assembled around the internal electronic circuits. In order to reduce the time taken to assemble the casings and the cost price of the mobile telephones, there is a tendency to avoid the use of assembly screws. Assembly is therefore achieved using complementary projecting and recessed profiles borne by the structural elements, whereby these complementary profiles providing a mechanical connection by the elements being elastically engaged together. The connection is thus achieved by clipping together the structural elements.

It has been found that the connecting of structural elements by elastic engagement does not give a reliable assembly. This is because, for ease of assembly and to allow easy manual disassembly, the elastically deformable elements which provide the elastic engagement need to be relatively flexible. Thus, the structural elements may easily become accidentally detached, particularly if the equipment is dropped. The rigidity of the elastic elements may be increased to improve the strength of the assembly. However, in such a configuration it is then no longer possible for the structural elements of the mobile telephone be disassembled manually.

### SUMMARY OF THE INVENTION

The present invention provides a solution to the above problem of the reliability of the assembly of the structural elements of the casing of electronic equipment, which allows easy, quick and therefore economical assembly of the structural elements and which in addition is compatible with easy manual disassembly thereof.

To this end, the subject matter of the present invention is a casing for electronic equipment of the aforementioned type, where a structure for mechanical connection by elastic engagement includes removable means for immobilizing a projection facing a shoulder.

More specifically, the present invention relates to a casing for electronic equipment including a first structural element, a second structural element and means for mechanically connecting the first and second structural elements by elastic engagement. The means for mechanical connection by elastic engagement includes an elastically deformable leg integral with the first structural element, and a projection borne by one of the leg or the second structural element, where the projection extends transversely to the leg when the first and second structural elements are connected. The means for mechanical connection by elastic engagement further includes a shoulder formed on the other of either the leg or the second structural element. The shoulder extends transversely to the leg when the first and second structural elements are connected, and the projection is arranged facing the shoulder when the first and second structural elements are connected, wherein the shoulder then constitutes a stop configured to collaborate with the projection and hold the leg in place.

According to some particular embodiments, the casing has one or more of the following features:

the removable immobilizing means of the projection facing the shoulder include a stop for immobilizing the leg, where the immobilizing stop is configured to lie along the leg on the opposite side of the leg to the projection when the first and second structural elements are connected;

the second structural element has a slot for the passage of the leg, and the stop for immobilizing the leg includes a tongue configured to be accommodated in the passage slot along the leg;

the tongue has transverse dimensions configured to approximately fill the entire gap separating the leg from the edge of the passage slot on the opposite side of the leg to the projection;

the projection is borne by the leg and the shoulder is formed within the second structural element; and

the casing includes a third structural element and the removable means for immobilizing the projection facing the shoulder are made as one piece with the third structural element.

A further subject matter of the present invention is mobile telecommunication equipment including a casing as defined hereinabove.

In an alternative form, the equipment further includes a removable battery and a movable cover for covering the battery, and the removable means for immobilizing the projection facing the shoulder are integral with the movable cover for covering the battery. The equipment further includes a removable battery, and the removable means for immobilizing the projection facing the shoulder are integral with the battery.

In particular, the mobile telecommunications equipment is a portable telephone.

### BRIEF DESCRIPTION OF THE DRAWINGS

A more complete appreciation of the invention and many of the attendant advantages thereof will become readily apparent with reference to the following detailed description, particularly when considered in conjunction with the accompanying drawings, in which:

FIG. 1 is an exploded, perspective view of the casing of a mobile telephone according to the invention;

FIG. 2 is a partial, cross-sectional view of the casing of FIG. 1, taken on a plane transverse to the means of mechanical connection by elastic engagement which provides the mechanical connection between at least two structural elements of the casing; and

FIG. 3 is a perspective view of a battery configured to be fitted into an alternative form of a mobile telephone casing according the invention.

### DETAILED DESCRIPTION OF THE PREFERRED EMBODIMENTS

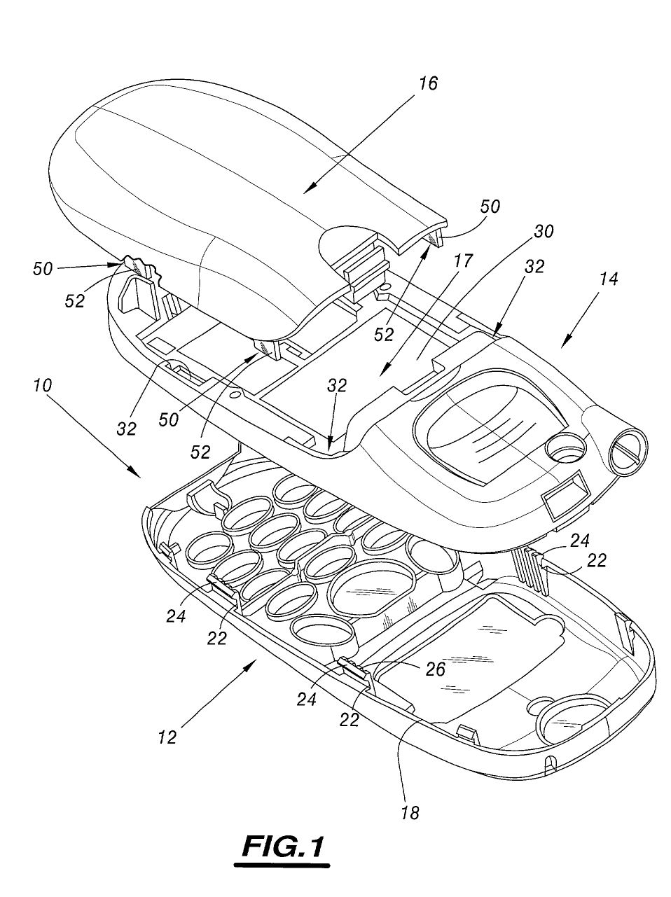

The casing 10 depicted in FIG. 1 is a mobile telephone casing. The casing 10 includes a front half-shell 12, a rear half-shell 14 and a battery cover 16. The front half-shell 12 is configured to take a keypad and a display screen. The rear half-shell 14 externally defines a housing 17 for accommodating a battery, and the cover 16 is configured to close this housing and hold the power battery therein.

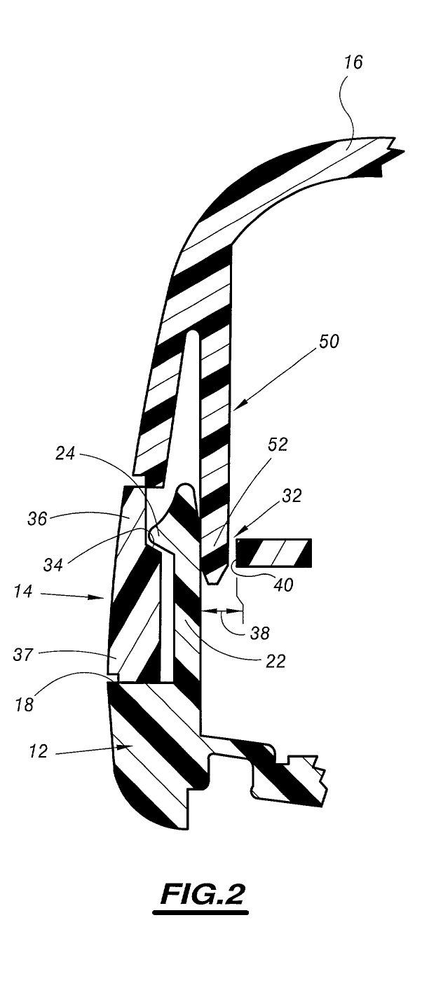

The half-shells 12 and 14 are connected together in ajoining mid-plane 18 running along the length of the casing. The half-shells 12 and 14 are held together by means of mechanical connection by elastic engagement. These means are formed in four regions spread around the periphery of the joining plane 18 of the half-shells. The means are depicted in FIG. 2 in a position in which they connect the half-shells 12 and 14. The various constituent parts of the connecting means are shown in FIG. 1, in which they are separated.

In the embodiment depicted in FIGS. 1 and 2, the connecting means include an elastically deformable leg 22 integral with the front half-shell 12. The leg 22 is formed as an integral part of the front half-shell 12. The leg 22 extends generally at right angles to the joining plane 18. The leg 22 has a free end with a projection 24 which projects from the overall plane of the leg 22, where the projection 24 faces towards the outside of the casing. On its opposite face to the face bearing the projection 24, the leg 22 has longitudinal stiffening ribs 26. The projection 24 extends across the entire width of the leg 22, more or less parallel to the joining plane 18.

The housing 17, which intended to take the battery, has a bottom 30 able to form a bearing surface for the battery. Slots 32 are formed in the bottom 30 facing the legs 22. The slots 32 are configured for the passage of the legs. Each slot 32 is bordered on one side by a shoulder 34. The shoulder 34 is formed on the exterior surface of the bottom 30 on the opposite side to the front half-shell 12 when the two half-shells are assembled. The shoulder 34 extends along that side of the slot towards which the projection 24 faces when the half-shells are assembled, i.e. towards the outside of the casing.

As illustrated in FIG. 2, the shoulder 34 is defined between the slot 32 for the passage of the leg 22 and an extension 36 of a side wall 37 of the rear half-shell 14. Moreover, the width of the slot 32 in the plane of FIG. 2 is greater than the thickness of the leg 22 in its main portion, so as to allow for the passage of the projection 24, where the latter locally increases the thickness of the leg 22. The leg 22, with the projection 24, is configured to collaborate with the shoulder 34 and thus provide a mechanical connection by elastic engagement of the half-shells 12 and 14.

For this purpose, and as illustrated in FIG. 2, when the half-shells 12, 14 are assembled, the end of the leg 22 passes through the bottom 30 through the slot 32. The projection 24 is then housed beyond the exterior surface of the bottom 30 and extends facing the shoulder 34. The shoulder 34 therefore constitutes a stop configured to collaborate with the projection 24 and thus hold the leg 22 in place. In this position, there is a gap 38 defined between the opposite surface of the leg 22 to the projection 24 and the edge facing it, denoted 40, of the slot 32.

According to the invention, the means of mechanical connection by elastic engagement include removable means 50 for immobilizing the projection 24 facing the shoulder 34. Thus, all the structural elements of the casing are held locked in their assembly position and therefore remain fully secured together. In this way, any accident befalling the portable telephone, such as the telephone being dropped, will not cause the structural elements of the telephone to become unintentionally disassembled.

The removable immobilizing means include a stop for immobilizing the leg 22. The stop is formed by a tongue 52 configured to run along the leg 22 on the opposite side to the projection 34 when the leg is passed through the slot 32. The tongue 52 therefore extends into the gap 38. The thickness of the tongue 52 is advantageously more or less equal to or very slightly less than the width of the gap 38.

In the embodiment depicted in FIGS. 1 and 2, the tongue 52 is formed as an integral part of the battery cover 16. Thus, no additional parts attached within the portable telephone for, in particular, on the one hand, holding the front 12 and rear 14 half-shells in their assembled position and, on the other hand, allowing easy deliberate disassembly of these half-shells 12, 14, need be provided. Thus, because the tongue 52 is integrated into an existing structural element of the casing of the mobile telephone (in this particular instance the battery cover 16), implementing the first embodiment described above, and implementing a second embodiment described below, represent a negligible cost.

When the mobile telephone is in a use configuration, the front 12 and rear 14 half-shells are connected together by the elastic engagement of the legs 22 in the slots 32, and the cover 16 is held on the rear half-shell 14. Each tongue 52 is then inserted between the opposite surface of the leg 22 to the associated projection 24 and the edge 40 of the corresponding slot 32. The tongue immobilizes the projection 24 facing the associated shoulder 34.

Specifically, when tension with a view to releasing the projection 24 is exerted on a leg 22, the leg 22 presses on the tongue 52, which opposes the elastic deformation of the leg 22. If the pulling force is very intense, the leg 22 and the tongue 52 deform slightly under the action of the projection 24 collaborating with the shoulder 34 which acts as a cam. This deformation continues until the tongue 52 comes to rest against the edge 40 of the slot. In this position, the leg 22 is locked in place by the tongue 52 resting against the edge 40, so that the tongue 52 can no longer elastically deform. The projection 24 is thus mechanically held facing the shoulder 34 without the projection 24 being able to escape.

It will thus be appreciated that the assembly of the half-shells 12 and 14 is made more reliable, as long as the cover 16 is held in place.

To disassemble the mobile telephone, removing the cover 16 allows the tongues 52 to be withdrawn from the slots 32. It is then possible for a user of the mobile telephone, by accessing them from the battery housing 17, to pull on the free end of each of the legs 22 using his finger and elastically deform them towards the inside of the mobile telephone, transversely to each projection 24. Thus, the user can easily disengage each projection 24 from the associated shoulder 34 in order to allow the front 12 and rear 14 half-shells to come apart and therefore be disassembled. It is to be noted that no additional special-purpose tools are required for disassembling the mobile telephone.

It will thus be appreciated that the means for immobilizing the projections give the connection of the half-shells great reliability when the telephone is in a use configuration. However, once the battery cover 16 has been removed, it is easy to disassemble the mobile telephone with a view to possible intervention on the elements located between the two half-shells.

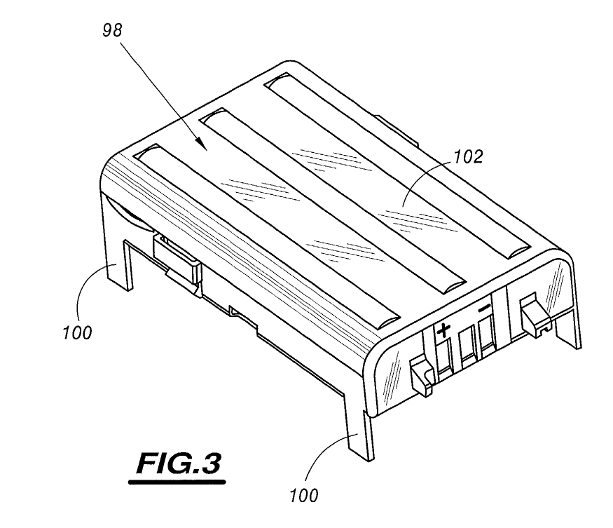

FIG. 3 depicts a battery 98 which can be used in an alternative form of a mobile telephone including a casing according to the invention. This alternative form differs from the one described with reference to FIGS. 1 and 2 only in that the cover 16 has no tongues 52 for immobilizing the projections borne or supported by the legs facing the associated shoulders.

By contrast, in the second embodiment, and as illustrated in FIG. 3, tongues or stops 100 are formed as an integral part of a body 102 of the battery, inside which the electric energy accumulators are housed. The tongues 100 are configured to be housed in the slots 32 in the rear half-shell 14. In a manner similar to the tongues 52, the tongues 100 are inserted between the legs 22 and the edge of the slots facing them.

In the embodiments depicted in FIGS. 2 and 3, the projections of the mechanical connecting means are borne by the elastic legs, whereas the shoulders collaborating with the projections are formed on the other structural element of the casing. As an alternative, the shoulders are formed on the elastic legs and the projections are borne by the complementary structural element of the casing. Likewise, according to another embodiment of the invention, the legs are integral with the rear half-shell 14 and the shoulders are then formed in the front half-shell 12.

In the previous descriptions, numerous specific details are set forth, such as specific materials, structures, processes, etc., in order to provide a thorough understanding of the present invention. However, as one having ordinary skill in the art would recognize, the present invention can be practiced without resorting to the details specifically set forth. In other instances, well known processing structures have not been described in detail in order not to unnecessarily obscure the present invention.

Numerous modifications and variations of the present invention are possible in light of the above teachings. It is therefore to be understood that, within the scope of the appended claims, the invention may be practiced otherwise than as specifically described herein.

What is claimed is:

1. A casing for electronic equipment comprising:
a first structural element;
a second structural element; and
means for mechanically connecting the first and second structural elements by elastic engagement, the means for mechanical connection by elastic engagement comprising:
an elastically deformable leg integral with the first structural element;
a projection borne by the leg or the second structural element, the projection extending transversely to the leg when the first and second structural elements are connected; and
a shoulder formed on the other of the leg or the second structural element, the shoulder extending transversely to the leg when the first and second structural elements are connected, the projection being arranged facing the shoulder when the first and second structural elements are connected, the shoulder then constituting a stop configured to collaborate with the projection and hold the leg in place,
wherein the means for mechanical connection by elastic engagement comprise removable means for immobilizing the projection facing the shoulder, the removable immobilizing means comprising a stop for immobilizing the leg, the immobilizing stop being configured to lie along the leg on the opposite side of the leg to the projection when the first and second structural elements are connected,
wherein the second structural element has a slot for the passage of the leg, and
wherein the stop for immobilizing the leg comprises a tongue configured to be accommodated in the passage slot along the leg, between the leg and an edge of the passage slot.

2. The casing according to claim 1, wherein the tongue has transverse dimensions configured to substantially fill an entire gap separating the leg from the edge of the passage slot on an opposite side of the leg to the projection.

3. The casing according to claim 1, wherein the projection is borne by the leg and the shoulder is formed within the second structural element.

4. The casing according to claim 2, wherein the projection is borne by the leg and the shoulder is formed within the second structural element.

5. The casing according to claim 1, further comprising a third structural element, and wherein the removable means for immobilizing the projection facing the shoulder are made as one piece with the third structural element.

6. The casing according to claim 2, further comprising a third structural element, and wherein the removable means for immobilizing the projection facing the shoulder are made as one piece with the third structural element.

7. The casing according to claim 3, further comprising a third structural element, and wherein the removable means for immobilizing the projection facing the shoulder are made as one piece with the third structural element.

8. Mobile telecommunication equipment comprising a casing according to claim 1.

9. The mobile telecommunication equipment according to claim 8, further comprising a removable battery and a movable cover configured to cover the battery, wherein the removable means for immobilizing the projection facing the shoulder are integral with the movable cover.

10. The mobile telecommunication equipment according to claim 8, further comprising a removable battery, wherein the removable immobilizing means are integral with the battery.

11. The mobile telecommunication equipment according to claim 8, wherein the mobile telecommunication equipment is a portable telephone.

12. The mobile telecommunication equipment according to claim 9, wherein the mobile telecommunication equipment is a portable telephone.

13. The mobile telecommunication equipment according to claim 10, wherein the mobile telecommunication equipment is a portable telephone.

14. A casing for electronic equipment comprising:
a first structural element having an elastically deformable leg;
a second structural element;
a projection borne by the leg or the second structural element; and
a shoulder formed on the other of the leg or the second structural element, the projection being arranged facing the shoulder when the first and second structural elements are connected, the shoulder then constituting a stop configured to collaborate with the projection and hold the leg in place whereby the first and second structural elements are mechanically connected, wherein
the second structural element has a slot configured to receive the leg, and
the stop includes a tongue configured to be accommodated in the slot along the leg and between the leg and an edge of the slot.

15. The casing according to claim 14, wherein the tongue has transverse dimensions configured to substantially fill an entire gap separating the leg from the edge of the slot on an opposite side of the leg to the projection.

16. The casing according to claim 14, wherein the projection is borne by the leg and the shoulder is formed within the second structural element.

17. The casing according to claim 14, further comprising a third structural element, and wherein the stop is made as one piece with the third structural element.

18. Mobile telecommunication equipment comprising a casing according to claim 14.

19. The mobile telecommunication equipment according to claim 18, further comprising a removable battery and a movable cover configured to cover the battery, wherein the stop is integral with the movable cover.

20. The mobile telecommunication equipment according to claim 18, further comprising a removable battery, wherein the stop is integral with the battery.
